(19) United States
(12) Patent Application Publication
(10) Pub. No.: US 2009/0222677 A1
(43) Pub. Date: Sep. 3, 2009

(54) DISPLAY OF BLADE SERVER OPERATING SYSTEM INFORMATION

(75) Inventors: Tara ASTIGARRAGA, Vail, AZ (US); Ayodele FAKOLUJO, Tucson, AZ (US); Sheri L. JACKSON, Tucson, AZ (US); Rotimi B. OJO, Tucson, AZ (US)

Correspondence Address: GRIFFITHS & SEATON PLLC (IBM), 2108 N. LEMON STREET, MESA, AZ, 85215, US

(73) Assignee: INTERNATIONAL BUSINESS MACHINES CORPORATION, Armonk, NY (US)

(21) Appl. No.: 12/039,984

(22) Filed: Feb. 29, 2008

(51) Int. Cl. G06F 15/173; G06F 1/26

(52) U.S. Cl. 713/300; 709/224

(57) ABSTRACT

A system, method, and computer program product for providing operating system information for a plurality of blade servers in a blade chassis to a management module for display to a user is provided. A first blade server of the plurality of blade servers is queried to determine operating system information for the first blade server. The operating system information is provided to the management module.

### BACKGROUND OF THE INVENTION

1. Field of the Invention

The present invention relates in general to computers, and more particularly to a method and computer program product for providing operating system information for a plurality of blade servers in a blade chassis to a management module for display to a user.

2. Description of the Related Art

Multiple blade servers are computers that consolidate high-density server boards (blades) in a single blade chassis (blade center chassis). Typically, a blade chassis accommodates multiple hot-swappable blades. The operations of the blades may be coordinated by management modules. Management modules may include a processor for controlling input/output functions, interfacing with a network (such as the Internet or a Local Area Network), and allocating jobs and data to the differing blades.

Currently, all blade servers that are part of a blade chassis or a stand-alone server require a user to physically come into contact with the unit if the user needs to perform functions associated with verifying the operating system or related operating system information installed on the blade server. The user must manually power on each blade, and one-by-one, connect to each blade to verify the blade's operating system information. The user must physically walk to the blade center chassis, and one-by-one, depress a video output button on each blade server. Alternatively, the user must perform the equivalent actions via a management module remote control.

The foregoing actions required by a user may present challenges if one of the blade servers is actively using video output, as the blade server temporarily loses video output capabilities during the activities described above. This is due to the video output transferred individually to each blade server in the blade chassis in order to gather operating system information.

### SUMMARY OF THE INVENTION

There is currently no centralized method to gather and view operating system information relating to each server blade in a blade server chassis from within the management module itself. In view of the foregoing, a need exists for a system, method and computer program product for providing operating system information for a plurality of blade servers in a blade chassis to a management module. Accordingly, in one embodiment, by way of example only, a method for providing operating system information for a plurality of blade servers in a blade chassis to a management module for display to a user is provided. A first blade server of the plurality of blade servers is queried to determine operating system information for the first blade server. The operating system information is provided to the management module.

In another embodiment, again by way of example only, a system for providing operating system information for a plurality of blade servers in a blade chassis to a management module for display to a user is provided. A scanning module is operational on the management module. The scanning module is configured to query a first blade server of the plurality of blade servers to determine operating system information for the first blade server, and provide the operating system information to the management module.

In still another embodiment, again by way of example only, a computer program product for providing operating system information for a plurality of blade servers in a blade chassis to a management module for display to a user is provided. The computer program product comprises a computer-readable storage medium having computer-readable program code portions stored therein. The computer-readable program code portions include a first executable portion for querying a first blade server of the plurality of blade servers to determine operating system information for the first blade server, and a second executable portion for providing the operating system information to the management module.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an exemplary server blade chassis incorporating a management module in which aspects of the claimed subject matter may be implemented; and

FIG. 2 is a flow chart diagram of an exemplary method for providing operating system information for a plurality of blade servers in a blade chassis to a management module for display to a user.

### DETAILED DESCRIPTION OF THE DRAWINGS

The illustrated embodiments below provide mechanisms for incorporating operating system (OS) scan functionality within the management module of a blade server computing environment. The OS information could include such information as operating system, operating system level, operating system version, operating system kernel, operating system patch, and the like. The OS information may be collected by the below mechanisms and stored and listed in a pre-existing or newly created table maintained by the management module. The OS information may be maintained in a simple format. Using the management module, each blade server in the blade server chassis may be queried to return relevant OS information.

The mechanisms described below provide for the rapid and efficient gathering of OS information on blade servers within a particular blade server chassis. In computing environments containing a number of blade servers, these mechanisms save resources and time for users and system administrators. Further, normal video output capabilities may continue while the below mechanisms are in operation and the OS information is gathered, eliminating the current requirement of using the chassis video output to point to specific blade servers while gathering OS information.

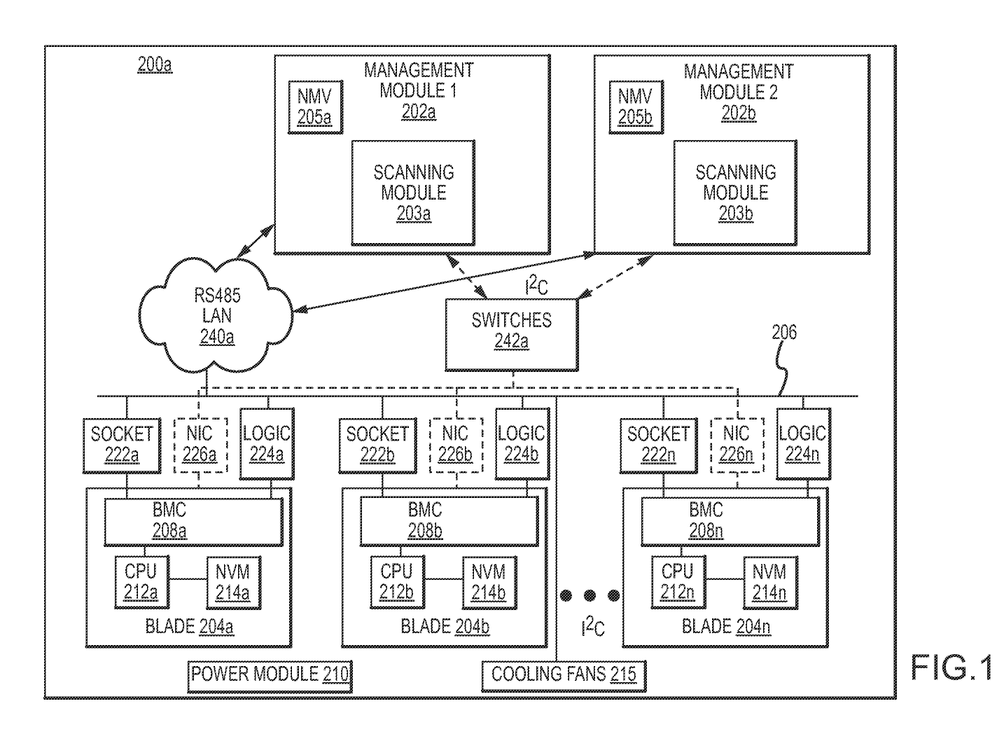

FIG. 1 hereafter provides one example of a computer environment in which the mechanisms of the following embodiments may be implemented. It should be appreciated, however, that FIG. 1 is only exemplary and is not intended to state or imply any limitation as to the particular architectures in which the exemplary aspects of the various embodiments may be implemented. Many modifications to the architecture depicted in FIG. 1 may be made without departing from the scope and spirit of the following description and claimed subject matter.

FIG. 1 is an exemplary block diagram of a server blade chassis 200a. For the sake of clarity, only three server blades 204a,b,n are depicted. However, in one embodiment, server blade chassis 200a has a midplane 206 capable of connecting fourteen or more server blades 204.

Server blade chassis 200a has one or more management modules 202. In the depicted embodiment, server blade chassis 200a has a primary management module 202a and a back-up management module 202b. Each management module 202 is capable of managing multiple server blades 204. During normal operations, one of the local management modules 202a or 202b are coupled to server blades 204a-n via a Local Area Network (LAN) 240a, a midplane 206, and a plurality of Baseboard Management Controllers (BMCs) 208 (each server blade 204 having a BMC 208) to form an in-band management pathway. LAN 240 and BMC 208 are discussed in further detail below.

Management modules 202a and 202b include scanning modules 203a and 203b. The functionality of such modules with respect to the present description and claimed subject matter will be also discussed below in further detail. Scanning modules may be implemented in hardware, software, firmware, or a combination thereof.

Midplane 206 is a backplane, mounted in the middle of server blade chassis 200a, that contains circuitry and sockets 222 into which additional electronic devices or cards, including server blades 204 may be inserted. Midplane 206 contains at least one bus for secure in-band internal communication between management module 202 and server blades 204a-n, as well as between and among server blades 204a-n themselves, via respective BMCs 208a-n.

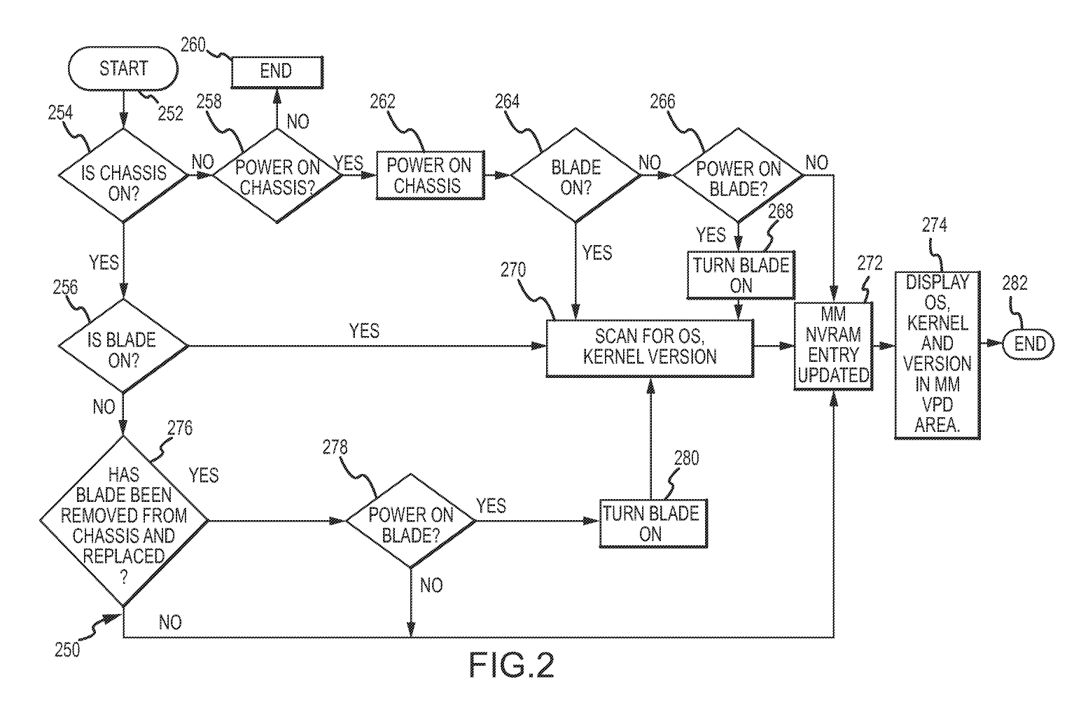

When a server blade 204 is inserted into a specific socket 222, a physical address is established for that server blade 204. For example, consider server blade 204a being inserted into socket 222a. A control logic 224a detects the presence of server blade 204a in socket 222a. Logic 224a may comport with the Electronics Industry Association (EIA) RS485 Standard for data communication. In other embodiments, Logic 224a may be compliant with the Phillips' Inter-IC (Inter-Integrated Circuit) standard (incorporated by reference in its entirety herein and commonly referred to as “I²C”), or with an Ethernet network standard. Logic 224a, operating in conjunction with management module 202, assigns a physical address on a bus in midplane 206 to server blade 204a when server blade 204a is inserted into socket 222a. Each server blade 204 may be associated with a unique logic 224 that is connected to midplane 206 as depicted in FIG. 2a. Alternatively, all server blades 204 may use a single logic 224.

Each server blade 204 may have a unique Internet Protocol (IP) address on midplane 206. That is, midplane 206 may support intercommunication using IP addressing protocol, in which each device connected or coupled to midplane 206 contains an IP address assigned by logic (not shown) that is either within or outside server blade chassis 200. For example, a Dynamic Host Configuration Protocol (DHCP) server may be used to assign an IP address to server blade 204a. Communication with server blade 204a is thereafter via a Network Interface Card (NIC) 226a that is associated with server blade 204a. The communication pathway using switches 242a and NICs 226 may be referred to as an out-of-band (OOB) network.

Each server blade 204 may have at least one central processing unit (CPU) 212, and a non-volatile memory (NVM) 214. NVM 214 is a Flash Read Only Memory (“Flash ROM” or “Flash Memory”) that can be erased and reprogrammed in units of memory referred to as “blocks.” NVM 214 may also include non-volatile Electrically Erasable Programmable Read Only Memory (EEPROM) that is similar to Flash Memory, except that EEPROM is erased and rewritten at the byte level and is usually smaller in capacity.

When a server blade 204 is shipped from a manufacturer, the NVM 214 may be pre-burned with firmware, including a BIOS as well as software for monitoring the server blade 204. Such monitoring may include controlling Direct Access Storage Devices (DASD's), monitoring and controlling voltages throughout the system, determining the power-on status of the server blade 204, requesting access to a shared keyboard, video, mouse, Compact Disk-Read Only Memory (CD-ROM) and/or floppy disk drives, as well as monitoring the Operating System (OS) running on the server blade 204.

Management modules 202 are capable of detecting the presence, quantity, type and revision level of each server blade 204, power module 210, and midplane 206 in the system. Management modules 202 may also directly control the operation of each server blade 204 and the power module 210, and may directly (without using the BIOS in the server blades 204) or indirectly (using the BIOS) control the operation of cooling fans 215 and other chassis 200a components. Management modules 202 are adapted to provide information relating to the configuration, operation, and modification of each server blade 204 in the chassis 200 to a graphical user interface (GUI) (not shown) for display to a user.

Each server blade 204 has a Baseboard Management Controller (BMC) 208 that provides local supervisory control of the server blade 204 to which the BMC 208 is associated. Each BMC 208 is able to communicate with a local management module 202 by either using communication path 240a (in-band network) or alternatively by using switches 242a and NICs 226 (out-of-band network). The local management modules 202a, 202b may utilize a variety of communications paths 240a, such as an RS485 path 240a, a LAN path 240a and an I²C path 240a to communicate with each blade 204.

LAN 240 is an in-band network also comporting with the Electronics Industry Association (EIA) RS485 Standard for data communication. Management modules 202 (either primary management module 202a or back-up management module 202b if management module 202a is down) communicate via LAN 240 with BMC 208, which includes logic for coordinating communication with server blades 204 via sockets 222. That is, the primary communication pathway between management module 202 and server blades 204 is the in-band network that comprises LAN 240, sockets 222, and BMC 208. The secondary communication pathway, which is used in the present invention if all of the local management modules 202 should fail, is the OOB network that comprises switches 242 and NICs 226.

LAN 240a may be configured to allow communications between server blades 204a-n and the management modules 202a, 202b relating to the remote BIOS settings and BIOS management. The blades 204a-n may leverage BMCs 208a-n as proxies to communicate with the management modules 202a, 202b through the RS485 protocol. Similarly, the management modules may leverage BMCs 208a-n as proxies to communicate with the blades 204a-n through the RS485 protocol. In an alternative embodiment, an RS485 connection may be separately made between each blade 204a-n and the management modules 202a, 202b. Additionally, other communications protocols and paths may be utilized, such as the aforementioned I²C channel or the aforementioned TCP/IP and/or Ethernet channel over switches 242a.

Scanning modules 203a, 203b, may be configured to perform scanning operations on each of the blades 204a-n in the server blade chassis 200a. For example, the scanning modules 203a and 203b may be adapted to query each of the blades 204a-n to determine OS information on the blades 204a-n. The OS information may be then returned to the scanning modules 203a and 203b operational on management modules 202a and 202b.

The information reported to the management modules 202a, 202b by the scanning modules 203a and 203b may include either high-level or detailed OS information. A particular high-level scan initiated by the scanning modules 203a, 203b may report an OS, such as UNIX. A more detailed scan initiated by the scanning modules 203a, 203b may report additional and/or related information such as OS level, application software version, kernel, patches, and the like as previously described.

Blade server installation and removal may be tracked on a per-bay basis within the scanning modules 203a and 203b and/or the management modules 202a and 202b. When a particular blade server is removed for service and/or installed, an NVRAM location 205a, 205b associated with the management modules 203a and 203b may be updated. For example, an entry of 1 may represent no changes since a previous scanning operation, and that the OS information currently stored in the NVRAM 205a, 205b is accurate. An entry of 0 may represent that the blade server was removed from the bay and/or an OS update or a change in the OS has occurred since the previous scanning operation. In addition, a scanning operation may be configured to occur when a blade server in the chassis is rebooted, and the NVRAM 205a, 205b may be updated to mark affected bay(s) accordingly.

Turning to FIG. 2, an exemplary method 250 is depicted for providing operating system information for a plurality of blade servers in a blade chassis to a management module for display to a user. As one skilled in the art will appreciate, various steps in the method 250 may be implemented in differing ways to suit a particular application. In addition, the described method may be implemented by various means, such as hardware, software, firmware, or a combination thereof operational on or otherwise associated with the storage environment. For example, the method may be implemented, partially or wholly, as a computer program product including a computer-readable storage medium having computer-readable program code portions stored therein. The computer-readable storage medium may include disk drives, flash memory, digital versatile disks (DVDs), compact disks (CDs), and other types of storage mediums.

Method 250 begins (step 252) with a determination of whether the blade server chassis is on (step 254). If the chassis is determined to be on, the method then determines whether a selected blade server is on (step 256). If the chassis is determined to be off, the method then queries whether the chassis should be powered on (step 258). This query may be provided to a user, who may request that the chassis be powered on. The user request to power on the chassis may take the form of a predetermined sequence embodied in a computer instruction, for example.

If the query returns that the chassis should not be powered on, then the method 250 ends (step 260). Otherwise, the method powers on the chassis (step 262). The method then, in a step similar to step 256, queries whether a particular blade server is on (step 264). If the particular blade is off, the method queries whether the particular blade should be powered on (step 266). Again, this query may be provided to a user, and the user request may come in response (whether predetermined or otherwise) to power the blade server on, in which the blade server is powered on (step 268).

The management module and/or scanning module may communicate with selected blade servers via an OOB connection, such as the RS-485 connection of LAN 250a (FIG. 1) and may issue the required commands to verify OS version(s), application software version(s), and the like using the OOB connection.

Once the chassis and a selected blade is determined to be on (pursuant to steps 256, 264, or 268), the scanning module(s) perform a scanning operation (step 270) on the blade server. The scanning operations may be a high-level, or detailed scan operation as previously described. The OS information is returned to the scanning modules, and provided to the management modules as previously described. Once the scanning operation(s) has completed, the management module NVRAM location is updated and the OS information may be displayed through the management module's GUI to a user. For example, the OS information may be displayed in the management module's vital product data (VPD) area. The method then ends (step 282).

Returning to step 256, if a selected blade is determined to not be powered on, the method queries whether the selected blade has been removed from the chassis and replaced, for example subsequent to a repair (step 276). If so, then the method queries, in similar fashion to step 266, whether pursuant to a user request, the blade server should be powered on (step 278). If yes, the method powers the selected blade server on (step 280), performs the scanning operation(s) (again, step 270), updates the NVRAM location (again, step 272), and displays the OS information (again, step 274). If the method determines that the selected blade has not been removed, the NVRAM location is updated with this information (again step 272) and the relevant OS information is displayed (again, step 274). The method then ends (again, step 282).

In one embodiment, various steps in the method 250 may be repeated for selected blade servers in the chassis until each blade server has been queried and the OS information for each blade server in the chassis is provided to the management module, the NVRAM location(s) are updated and the OS information is displayed. In another embodiment, the method 250 may be configured to occur at a predetermined frequency. In other embodiments, various portions of the method 250 may be configured to occur at various predetermined frequencies. Again, as one skilled in the art will anticipate, the method 250 may be adapted and implemented in various ways to suit a particular need or application.

While one or more embodiments of the present invention have been illustrated in detail, the skilled artisan will appreciate that modifications and adaptations to those embodiments may be made without departing from the scope of the present invention as set forth in the following claims.

What is claimed is:

1. A method for providing operating system information for a plurality of blade servers in a blade chassis to a management module for display to a user, comprising:
(a) querying a first blade server of the plurality of blade servers to determine operating system information for the first blade server; and
(b) providing the operating system information to the management module.

2. The method of claim 1, further including repeating steps (a) and (b) for each of the plurality of blade servers in the blade chassis.

3. The method of claim 1, further including updating a Non-Volatile Read Only Memory (NVRAM) location in the management module for the first blade server if the operating system information has changed subsequent to a previous query.

4. The method of claim 1, wherein querying the first blade server to determine operating system information for the first blade server further includes querying the first blade server for an operating system level, an operating system version, an operating system kernel, or an operating system patch.

5. The method of claim 1, further including:
determining if the blade chassis is on, and
pursuant to a user request, powering on the blade chassis if the blade chassis is off.

6. The method of claim 5, further including:
determining if the first blade server is on, and
pursuant to a user request, powering the first blade server on if the first blade server is off.

7. The method of claim 1, further including:
determining if the first blade server is on,
if the blade server is off, determining if the blade server has been removed from the blade chassis and replaced, and
pursuant to a user request, powering the first blade server on if the first blade server is off.

8. The method of claim 1, wherein querying the first blade server further includes accessing the first blade server via an out-of-band (OOB) connection.

9. A system for providing operating system information for a plurality of blade servers in a blade chassis to a management module for display to a user, comprising:
a scanning module operational on the management module, the scanning module configured to:
(a) query a first blade server of the plurality of blade servers to determine operating system information for the first blade server, and
(b) provide the operating system information to the management module.

10. The system of claim 9 of claim 1, wherein the scanning module is further configured to repeat steps (a) and (b) for each of the plurality of blade servers in the blade chassis.

11. The system of claim 9, wherein the scanning module is further configured to update a Non-Volatile Read Only Memory (NVRAM) location in the management module for the first blade server if the operating system information has changed subsequent to a previous query.

12. The system of claim 9, wherein the operating system information further includes an operating system level, an operating system version, an operating system kernel, or an operating system patch.

13. The system of claim 9, wherein the scanning module is further configured to:
determine if the blade chassis is on, and
pursuant to a user request, power on the blade chassis if the blade chassis is off.

14. The system of claim 13, wherein the scanning module is further configured to:
determine if the first blade server is on, and
pursuant to a user request, power the first blade server on if the first blade server is off.

15. The system of claim 9, wherein the scanning module is further configured to:
determine if the first blade server is on,
if the blade server is off, determine if the blade server has been removed from the blade chassis and replaced, and
pursuant to a user request, power the first blade server on if the first blade server is off.

16. A computer program product for providing operating system information for a plurality of blade servers in a blade chassis to a management module for display to a user, the computer program product comprising a computer-readable storage medium having computer-readable program code portions stored therein, the computer-readable program code portions comprising:
a first executable portion for querying a first blade server of the plurality of blade servers to determine operating system information for the first blade server; and
a second executable portion for providing the operating system information to the management module.

17. The computer program product of claim 16, further including a third executable portion for updating a Non-Volatile Read Only Memory (NVRAM) location in the management module for the first blade server if the operating system information has changed subsequent to a previous query.

18. The computer program product of claim 16, wherein querying the first blade server to determine operating system information for the first blade server further includes querying the first blade server for an operating system level, an operating system version, an operating system kernel, or an operating system patch.

19. The computer program product of claim 16, further including:
a third executable portion for determining if the blade chassis is on,
a fourth executable portion for, pursuant to a user request, powering on the blade chassis if the blade chassis is off,
a fifth executable portion for, determining if the first blade server is on, and
a sixth executable portion for, pursuant to a user request, powering the first blade server on if the first blade server is off.

20. The computer program product of claim 16, further including:
a third executable portion for determining if the first blade server is on,
a fourth executable portion for, if the blade server is off, determining if the blade server has been removed from the blade chassis and replaced, and
a fifth executable portion for, pursuant to a user request, powering the first blade server on if the first blade server is off.
